(19) United States
(12) Patent Application Publication
(10) Pub. No.: US 2022/0018668 A1
(43) Pub. Date: Jan. 20, 2022

(54) FACILITATING IMPLEMENTATION OF A MULTITUDE OF VIRTUAL PATHS FOR MOVING AN OBJECT IN ADVANCED NETWORKS

(71) Applicants: AT&T Intellectual Property I, L.P., Atlanta, GA (US); AT&T Global Network Services Slovakia, s.r.o., Bratislava (SK)

(72) Inventors: Craig Klein, San Antonio, TX (US); Gregory Harp, Allen, TX (US); Yeeling Lam, Bridgeton, MO (US); Mahendra Kuncham, Plano, TX (US); Barton K. Hawkins, San Antonio, TX (US); Filip Benuska, Rovinka (SK)

(21) Appl. No.: 16/928,388

(22) Filed: Jul. 14, 2020

(51) Int. Cl. G01C 21/34; G05D 1/00

(52) U.S. Cl. CPC G01C 21/3446; G01C 21/343; G05D 1/0027

(57) ABSTRACT

Facilitating implementation of a multitude of virtual paths for moving an object in advanced networks (e.g., 5G, 6G, and beyond) is provided herein. Operations of a method can include generating, by a system that includes a memory and a processor, a traversal route grid for travel of an object between a source node and a target node. The traversal route grid can include multiple alternative route segments between the source node and the target node. The method also can include assigning, by the system, respective values to alternative route segments of the multiple alternative route segments. The respective values can be tailored for the object and determined as a function of a requested time of arrival at the target node. Further, the method can include facilitating, by the system, the travel of the object along the group of alternative route segments.

### TECHNICAL FIELD

This disclosure relates generally to managing movement of objects in Fifth Generation (5G), Sixth Generation (6G), or other advanced networks and, more specifically, to a smart grid routing network.

### BACKGROUND

The use of computing devices is ubiquitous. These computing devices include radios and antenna elements, which allow the computing devices to communicate with other devices, as well as to access various communications networks (e.g., cellphone network, internet network, satellite network, and so on). Further, many devices have the capability of movement in three-dimensional space and/or the capability to direct the movement of other devices and/or objects. Unique challenges exist to provide real-time and coordinated movement of such devices and/or objects and in view of forthcoming 5G, 6G, or other next generation, standards for wireless communication.

### BRIEF DESCRIPTION OF THE DRAWINGS

Various non-limiting embodiments are further described with reference to the accompanying drawings in which:

FIG. 1 illustrates an example, non-limiting, system that facilitates implementation of a multitude of virtual paths for moving an object in accordance with one or more embodiments described herein;

FIG. 2 illustrates an example, non-limiting, system that facilitates assigning values to a route and moving an object in accordance with one or more embodiments described herein;

FIG. 3 illustrates an example, non-limiting, system that facilitates providing a multitude of virtual paths for moving multiple objects in accordance with one or more embodiments described herein;

FIG. 4 illustrates an example, non-limiting, system that employs automated learning to facilitate one or more of the disclosed aspects in accordance with one or more embodiments described herein;

FIG. 5 illustrates a flow diagram of an example, non-limiting, computer-implemented method for facilitating implementation of a multitude of virtual paths for moving an object in advanced networks in accordance with one or more embodiments described herein;

FIG. 6 illustrates a flow diagram of an example, non-limiting, computer-implemented method for altering a route based on changing conditions in accordance with one or more embodiments described herein;

FIG. 7 illustrates a flow diagram of an example, non-limiting, computer-implemented method for selecting between alternative routes in accordance with one or more embodiments described herein;

FIG. 8 illustrates a flow diagram of an example, non-limiting, computer-implemented method for changing a route based on a defined time of arrival in accordance with one or more embodiments described herein;

FIG. 9 illustrates a flow diagram of an example, non-limiting, computer-implemented method for benefiting a first object based on a change to a travel route of a second object in accordance with one or more embodiments described herein;

FIG. 10 illustrates a flow diagram of an example, non-limiting, computer-implemented method for providing value for use of a portion of a route in accordance with one or more embodiments described herein;

FIG. 11 illustrates an example block diagram of a non-limiting embodiment of a mobile network platform in accordance with various aspects described herein; and

FIG. 12 illustrates an example block diagram of an example computer operable to engage in a system architecture that facilitates wireless communications according to one or more embodiments described herein.

### DETAILED DESCRIPTION

One or more embodiments are now described more fully hereinafter with reference to the accompanying drawings in which example embodiments are shown. In the following description, for purposes of explanation, numerous specific details are set forth in order to provide a thorough understanding of the various embodiments. However, the various embodiments can be practiced without these specific details (and without applying to any particular network, networked environment or standard).

Described herein are systems, methods, articles of manufacture, and other embodiments or implementations that can facilitate implementation of a multitude of virtual paths for moving an object in advanced networks. For example, in a world of autonomous objects that move through space (latitude, longitude, altitude, time) controlled by one or more inanimate objects, every path can become a potential path that has a value, and this value can fluctuate based on the perceived need of the object or controller entity. Additionally, the value of a path can fluctuate with time. Such a path can persist for a short length, a long length, or a length amount therebetween. As used herein, “length” refers to distance and/or time. The ability to move objects via one or more paths selected based on a multitude of criteria that can fluctuate for a multitude of reasons can be facilitated with the disclosed aspects. In the transportation of objects today, cost paths (e.g. toll roads) are predetermined by assigned infrastructure (e.g., defined entrances and defined exits), that only fluctuates by cost and distance, not by path and the ability to pay based on one or more unique criteria.

Traditionally, paths are primarily defined by geometric coordinates (e.g., latitude and longitude), congestion, and distance. In the future, paths will not be physically defined (e.g. toll road) because every path has the possibility to be a road with a value. The value (e.g., from free or a zero-value amount to an X value amount) is defined by the controller, end user, and/or service provider, and not limited to a particular physical path in three-dimensional space and/or time. The ability of value to fluctuate in real time can exist and the ability to turn on and turn off paths can be handled by a controller, as mediated by one or more preferences (e.g., stated preference, implied preference, perceived preference, inferred preference, historical preference, and so on) of the one or more entities associated with the path (e.g., controller of the path, user of the path, owner of the path, and so on). These preferences, however formed, can change in real time. Offered paths thus can be highly dynamic rather than offered merely once at the initiation of travel, for example. Further, users and/or service providers (sometimes referred to as payers) could include not merely travelers but entities in proximity to travelers who can offer a preferred path of their own upon which the controller (or another entity) can either bid for or pay in real time (e.g., travel to Bob's Spoon to receives a discount), as measured by the preferences of the travelers. In a similar manner, a merchant could offer a discount equivalent to such fee as an incentive for customer acquisition. Additionally, as used herein, proximity can be, not only travelers but different cargo in, or on, a device or object that is moving.

According to an embodiment is a method that can include generating, by a system that includes a memory and a processor, a traversal route grid for travel of an object between a source node and a target node. The traversal route grid can include multiple alternative route segments between the source node and the target node. The method also can include assigning, by the system, respective values to alternative route segments of the multiple alternative route segments. The respective values can be tailored for the object and determined as a function of a requested time of arrival at the target node. Further, the method can include based on receipt of an acceptance of the respective values assigned to the alternative route segments of a group of alternative route segments, facilitating, by the system, the travel of the object along the group of alternative route segments.

In an example, the method can include adjusting, by the system, a second traversal route grid for a second object based on a determination that an adjustment to the second traversal route grid supports the requested time of arrival at the target node for the first object. Further to this example, the adjustment can include increasing a first value for a first segment of the multiple alternative route segments of the first traversal route grid. Further, the adjustment can include providing an incentive to the second object based on the adjustment to the second traversal route grid.

The traversal route grid can be represented as a three-dimensional space and a time element. The object can be a physical object moving in a three-dimensional space.

In an example, the object can be an autonomous vehicle. Further, generating the traversal route grid can include choosing a path from a group of paths based on a type of the autonomous vehicle. The object characteristics can be used as input to a path decision criteria. For example, choosing the path can include selecting a first path based on the autonomous vehicle being an electric-powered vehicle. Alternatively, choosing the path can include selecting a second path based on the autonomous vehicle being a gas-powered vehicle. Alternatively, choosing the path can include selecting a third path based on the autonomous vehicle being a hybrid-powered vehicle.

According to some implementations, generating the traversal route grid can include determining that an availability of a first route segment of the multiple alternative route segments is for a defined period of time. Further, generating the traversal route grid can include selecting the first route segment based on the availability of the first route segment corresponding to the requested time of arrival. Alternatively, generating the traversal route grid can include selecting a second route segment of the multiple alternative route segments based on the availability of the first route segment failing to correspond to the requested time of arrival. The first route segment and the second route segment can be interchangeable route segments.

In an example, a first route segment of the multiple alternative route segments can be a public route. A second route segment of the multiple alternative route segments can be a private route. Further, an owner of the private route can be compensated for a use of the private route.

In some implementations, the method can include, prior to facilitating the travel of the object, outputting, by the system, to a user equipment associated with the object, first information indicative of the respective values and second information indicative of the alternative route segments. Outputting the first and second information can be via a communications network configured to operate according to a Fifth Generation (5G) communication protocol, Sixth Generation (6G) communication protocol, or another advanced communication protocol.

According to some implementations, the method can include identifying, by the system, respective locations of objects, comprising the first object, within the traversal route grid. Further, the method can include modifying, by the system, a first travel route of the first object and a second travel route of a second object based on detection of occurrence of an event within a portion of the traversal route grid.

Another embodiment provided herein relates to a system that can include a processor and a memory that stores executable instructions that, when executed by the processor, facilitate performance of operations. The operations can include identifying a group of route paths between a source location of a movable object and a destination location of the movable object. The group of route paths can include a group of alternative route paths. In some implementations, the group of route paths can be associated with a defined travel value. Further, the operations can include directing a user equipment to travel between the source location and the destination location based on acceptance of the defined travel value and monitoring a group of events associated with the travel of the user equipment. The operations also can include changing a parameter of a route path of the group of route paths based on an event of the group of events being determined to influence a time of arrival at the destination location.

In an example, the event can be an object travel congestion on the route path and changing the parameter can include changing a location of a second user equipment on the route path. Further to this example, changing the location can include causing the second user equipment to move to a defined position in the route path. In another example, changing the location can include causing the second user equipment to move to an alternative route path other than the route path.

The user equipment can be classified as a type of device capable of horizontal movement and vertical movement. In another example, the user equipment can be configured to operate according to a 5G communication protocol.

Another embodiment provided herein is a non-transitory machine-readable medium, comprising executable instructions that, when executed by a processor, facilitate performance of operations. The operations can include identifying an entity associated with a defined portion of a route that includes multiple portions, including the defined portion. The operations also can include ascertaining a value for the defined portion based on a parameter associated with the defined portion. Further, the operations can include providing the value as an incentive for use of the defined portion by movable objects that are traversing between a starting point and an ending point. The defined portion can be included in respective routes traversed by the movable objects.

In an example, the parameter can include an amount of time saved by the movable objects when traversing the defined portion as compared to use of an alternative route by the movable objects. In another example, the value for the defined portion can be changeable based on a number of movable objects using the defined portion during an identified time period.

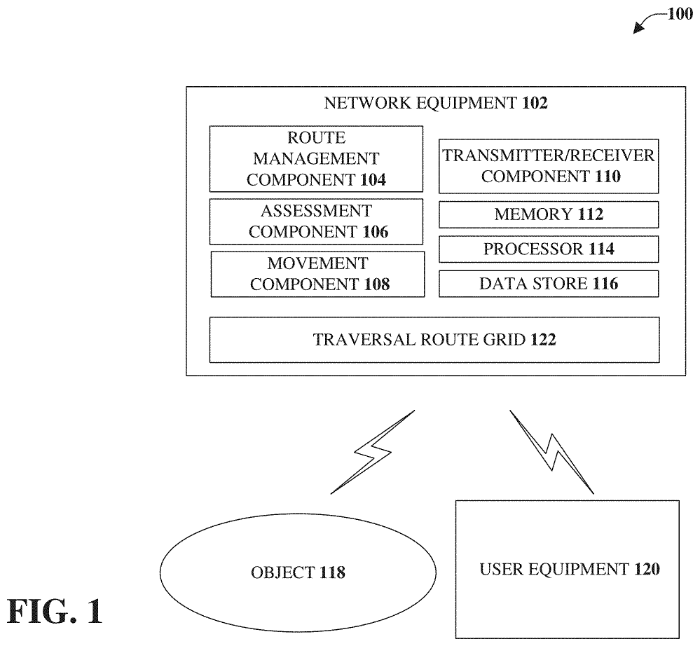

FIG. 1 illustrates an example, non-limiting, system 100 that facilitates implementation of a multitude of virtual paths for moving an object in accordance with one or more embodiments described herein. The system 100 (as well as other systems discussed herein) can include a combination of controllers, data stores, authentication, billing, smart grids, control planes, and/or gateways. The system 100 can include network equipment 102, which can include a route management component 104, an assessment component 106, a movement component 108, a transmitter/receiver component 110, at least one memory 112, at least one processor 114, and at least one data store 116. The network equipment 102 can be in communication with at least one movement item or object 118. The object 118 can be various movable items such as, for example, an autonomous vehicle, a drone, a train, a ship, a package, a box of food, a pizza, a person, and so on. The object can be any physical object capable of movement in a three-dimensional space and/or a four-dimensional time-space. Further, although various aspects are discussed with a single object, the disclosed aspects are not limited to this implementation and more than one object can be moved as discussed herein.

The object 118 can be capable of communication and can be associated with a user equipment 120. Further the object 118 can have specific attributes (e.g., it can fly, it can go fast enough, the amount of energy available, and so on). Although not illustrated, the object 118 and/or the user equipment 120 can respectively include a transmitter/receiver component, one or more memories, one or more processors, and one or more data stores. In some implementations, the object 118 and the user equipment 120 can be separate, as illustrated. For example, if the object 118 is a package (e.g., that contains pharmacy prescriptions), the object 118 can be conveyed by a drone, which can be utilized as the user equipment 120, and, thus, are capable of being separated. However, in some implementations, the object 118 and the user equipment 120 can be co-located, such as in the case of an autonomous vehicle or the drone itself if the drone is being moved between locations.

Further, the communication between the network equipment 102 and the object 118 and/or user equipment 120 can occur within a communications network and/or across space and/or across multiple communications networks. For example, the disclosed aspects can be utilized locally within a city, across a state, among different states, different countries, and/or globally. Although a single network equipment, a single object, and a single user equipment are illustrated, according to various implementations, more than one network equipment, more than one object, and/or more than one user equipment can be included in the system 100.

Aspects of systems (e.g., the system 100 and the like), apparatuses, or processes explained in this disclosure can constitute machine-executable component(s) embodied within machine(s) (e.g., embodied in one or more computer readable mediums (or media) associated with one or more machines). Such component(s), when executed by the one or more machines (e.g., computer(s), computing device(s), virtual machine(s), and so on) can cause the machine(s) to perform the operations described.

In various embodiments, the network equipment 102, the object 118, and/or the user equipment 120 can be any type of component, machine, device, facility, apparatus, and/or instrument that includes a processor and/or can be capable of effective and/or operative communication with a wired and/or wireless network. Components, machines, apparatuses, devices, facilities, and/or instrumentalities that can include the network equipment 102, the object 118, and/or the user equipment 120 can include tablet computing devices, handheld devices, server class computing machines and/or databases, laptop computers, notebook computers, desktop computers, cell phones, smart phones, consumer appliances and/or instrumentation, industrial and/or commercial devices, hand-held devices, digital assistants, multimedia Internet enabled phones, multimedia players, heretofore non-commercialized or concept devices (e.g., Internet Protocol (IP) aware contact lenses), and the like.

The route management component 104 can generate a traversal route grid 122 (e.g., a smart grid) for travel of the object 118. For example, an entity associated with the object 118 and/or the user equipment 120 can provide a request that includes an indication of a desired travel of the object 118 from a first position (also referred to as source location, a source node, a first location, and so on) to a second position (also referred to as target location, a target node, a second location, and so on). As utilized herein an entity can be one or more computers, the Internet, one or more systems, one or more commercial enterprises, one or more computers, one or more computer programs, one or more machines, machinery, one or more actors, one or more users, one or more customers, one or more humans, and so forth, hereinafter referred to as an entity or entities depending on the context.

The request of the desired travel can include, but is not limited to, a “from” location, a “to” location, a departure time, an arrival time, a guaranteed duration, and so on. According to some implementations, the request can include one or more manageable parameters. For example, a manageable parameter can be a fuel consumption.

According to some implementations, an indication can be received to move the object 118 from the first position, to a second position, then to a third position, and so on. For example, it could be desired to move the object from a starting position to a first destination, then from the first destination to a second destination, and so on. Accordingly, the traversal route grid 122 can be utilized for each source location and target location and/or can be utilized for the entire trip. Each leg of the trip, or the entire trip, can include multiple route segments between the source node and the target node. According to some implementations, the traversal route grid 122 can be represented as a three-dimensional space and a time element.

Every path can have a value to an entity (e.g., an end user, an object, a person, a business, and so on) and this value can fluctuate over time. The system 100 can provide the ability to determine, for every path in a four-dimensional world (latitude, longitude, altitude, and time), a unique value based on the path, the path's owner, and the immediate or future need of the traveler.

The assessment component 106 can assign respective values to the alternative route segments of the multiple alternative route segments. For example, the assessment component 106 can assign a first value to a first route segment, a second value to a second route segment, a third value to a third route segment, and so on. The respective values assigned by the assessment component 106 can be tailored for the object 118. Additionally, or alternatively, the respective values assigned by the assessment component 106 can be determined as a function of a requested time of arrival at the target node.

First information indicative of the respective values and second information indicative of the alternative route segments can be output to a user equipment 120 associated with the object 118. For example, the object can be a package and, therefore, the first information and second information can be output to a mobile device, computer, or other device associated with the entity. The output of the first information and the second information can be in a communications network configured to operate according to a fifth generation communication protocol, a sixth generation communication protocol, or another advanced communication protocol.

If the respective values are approved or accepted by the entity associated with the object 118, the movement component 108 can facilitate the travel of the object 118 along the group of alternative route segments. For example, the movement component 108 can provide directions related to the route(s) that should be taken by the object 118. In another example, the movement component 108 can provide a visual electronic map that can be utilized to move the object 118. In yet another example, the movement component 108 can control the object 118, at least partially, to cause the object 118 to move. Other manners of facilitating the movement of the object 118 can be provided by the movement component 108.

The object 118 can have a unique identifier that can be tracked by the movement component 108. The identifier can be, but is not limited to, an Internet Protocol (IP) address, an International Mobile Equipment Identity (IMEI), or another physical and/or logical parameter enabled by the system 100.

According to some implementations, the object can be an autonomous vehicle and the route management component 104 can choose a path from a group of paths based on a type of the autonomous vehicle. Thus, according to various embodiments, object characteristics can be used as input to a path decision criteria. For example, if the autonomous vehicle is an electric-powered vehicle, a first path can be selected. The first path can provide better opportunities for recharging the electric-powered vehicle as compared to other paths. If the autonomous vehicle is a gas-powered vehicle, a second path can be selected. The second path can provide better opportunities for fueling the gas-powered vehicle as compared to other paths. Further, if the autonomous vehicle is a hybrid vehicle, a third path can be selected. The third path can provide better opportunities for charging and/or fueling the hybrid vehicle as compared to other paths. The first path, the second path, and the third path can be different paths. In some implementations, at least two of the first path, the second path, and the third path can be the same path.

The transmitter/receiver component 110 can receive, from the object 118 and/or the user equipment 120 the request to move from a first location, which can be a current location, to one or more other locations, a requested time of arrival at each of the one or more other locations, acceptance of the respective values, denial of the respective values, and/or other information. Further, the transmitter/receiver component 110 can send to the object 118 and/or the user equipment 120 the first information, the second information, and/or other information.

The at least one memory 112 can be operatively connected to the at least one processor 114. The at least one memory 112 can store executable instructions that, when executed by the at least one processor 114 can facilitate performance of operations. Further, the at least one processor 114 can be utilized to execute computer executable components stored in the at least one memory 112.

For example, the at least one memory 112 can store protocols associated with facilitating providing multitude of virtual paths for moving an object an advanced network as discussed herein. Further, the at least one memory 112 can facilitate action to control communication between the object 118 and/or the user equipment 120, the network equipment 102, one or more other network equipment, one or more other objects, one or more other user equipment, and so on, such that the network equipment 102 can employ stored protocols and/or algorithms to facilitate providing a multitude of virtual paths for moving an object in advanced networks as described herein.

It should be appreciated that data stores (e.g., memories) components described herein can be either volatile memory or nonvolatile memory, or can include both volatile and nonvolatile memory. By way of example and not limitation, nonvolatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of example and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory of the disclosed aspects are intended to include, without being limited to, these and other suitable types of memory.

The at least one processor 114 can facilitate respective analysis of information related to virtual paths and providing a multitude of virtual paths for moving an object in advanced networks. The at least one processor 114 can be a processor dedicated to analyzing and/or generating information received, a processor that controls one or more components of the network equipment 102, and/or a processor that both analyzes and generates information received and controls one or more components of the network equipment 102.

Further, the term network equipment is used herein to refer to any type of network node serving UE and/or connected to other network equipment, network nodes, network elements, or another network node from which the UEs can receive a radio signal. In cellular radio access networks (e.g., universal mobile telecommunications system (UMTS) networks), network nodes can be referred to as base transceiver stations (BTS), radio base station, radio network nodes, base stations, NodeB, eNodeB (e.g., evolved NodeB), and so on. In 5G terminology, the network nodes can be referred to as gNodeB (e.g., gNB) devices. Network nodes can also include multiple antennas for performing various transmission operations (e.g., MIMO operations). A network node can include a cabinet and other protected enclosures, an antenna mast, and actual antennas. Network nodes can serve several cells, also called sectors, depending on the configuration and type of antenna. Examples of network nodes can include but are not limited to: NodeB devices, base station (BS) devices, access point (AP) devices, and radio access network (RAN) devices. The network nodes can also include multi-standard radio (MSR) radio node devices, comprising: an MSR BS, an eNode B, a network controller, a radio network controller (RNC), a base station controller (BSC), a relay, a donor node controlling relay, a base transceiver station (BTS), a transmission point, a transmission node, a Remote Radio Unit (RRU), a Remote Radio Head (RRH), nodes in distributed antenna system (DAS), and the like.

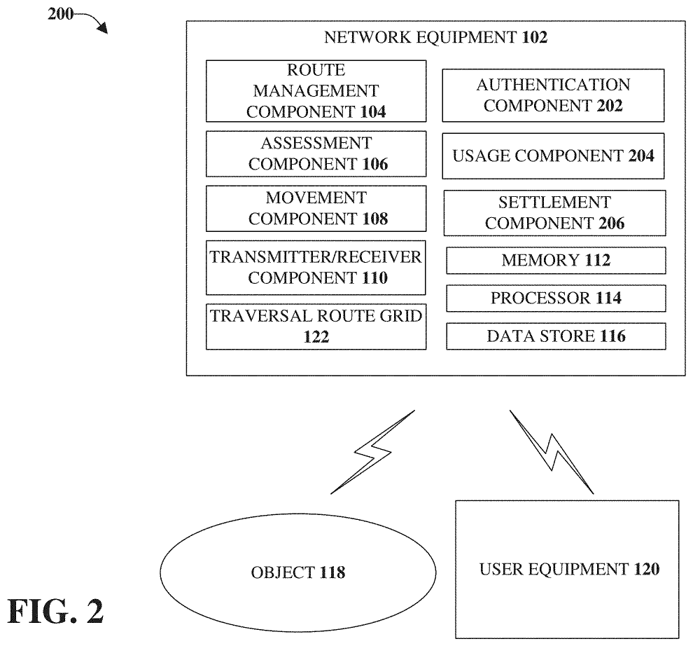

FIG. 2 illustrates an example, non-limiting, system 200 that facilitates assigning values to a route and moving an object in accordance with one or more embodiments described herein. Repetitive description of like elements employed in other embodiments described herein is omitted for sake of brevity. The system 200 can include one or more of the components and/or functionality of the system 100, and vice versa.

As illustrated, the network equipment 102 can include an authentication component 202 that can authenticate use of the system 200 by the object 118 and/or the user equipment 120. For example, the authentication component 202 can interact with the at least one data store 116, which can be an authentication and registration data store according to some implementations. Further, the authentication component 202 can register the object and/or user equipment 120 for use of the system. According to some implementations, the authentication and registration data store can be included, at least partially, on the object 118 and/or the user equipment 120.

The network equipment can include a management plane that can be utilized for value and a control plan that can be utilized for traffic control. The route management component 104 and/or the traversal route grid 122 can communicate with the management plane.

The assessment component 106, according to some implementations, can determine one or more determinants for use of a particular route. Such determinants include, but are not limited to, time, energy used, speed, weather, popularity of the route, whether the route is scenic or not, places to dine along the route, path closures, and so on. The determinants can be temporary or permanent and can affect the decision criteria of the assessment component 106. Further, the assessment component 106 can split the value of the route if there are multiple requestors together. For example, if a group of people are traveling to a same destination (e.g., group vacation) and all the autonomous vehicles associated with the group of people are expected to be together, the value of the route can be divided among the different autonomous vehicles. Alternatively, multiple occupants in a single autonomous vehicle can divide the expenses.

As discussed, the path and value, which can be a cost of using the system 200, are submitted to an end user for acceptance and/or rejection. If accepted, the information is registered in the at least one data store 116 (or another data store located within the system 100 or external to the system 100) for billing purposes. Additionally, if accepted, the movement component 108, through use of the traversal route grid 122, can manage priority of the object 118 thru the network (e.g., through the four-dimensional space-time grid) from a first location to a second location (and/or to a subsequent location). The path value can be from “zero” (e.g., no charge) to “X,” where X is a positive-valued real number.

In some cases, one or more paths requested will denied because no benefit can be gained from using the path. For example, there might be too many requests for the path, causing congestion on the path. In another example, the requested path might be blocked due to an accident, construction, natural disaster, and so on. According to some implementations, the assessment component 106 can offer one or more paths through an “auction-type” setting, which can be utilized when demand for the one or more paths exceeds the supply (e.g., numerous requests for a same time period, numerous request that will cause one or more objects to be traveling the path at the same time, causing delays for all users, and so on). According to some implementations, the assessment component 106 can oversubscribe objects with little to almost no risk. For example, if too many objects are expected to be traversing a path at the same time, one or more objects can be provided an incentive to use a different path, stop for a while, or perform another action in order to allow other objects the ability to use the path unhindered. This can be similar to an airline overbooking a flight where one or more passengers are given an incentive to take a different flight.

According to some implementations, one or more paths can be controlled by entities outside of the smart grid routing network. For example, there can be a private property inside of a municipality, such as a ranch, which can provide a more direct route or a less congested route, as compared to a public road. A usage component 204 can allow the owners of the private paths to add their respective path the smart grid routing network, the owners can be compensated for use of the private paths. The utilization of the private paths can be managed by the usage component 204. For example, the addition of the private paths can be automatic based on predetermined criteria, which can include, but is not limited to, demand, time of day, weather, situation, price level demand, and so on. For example, private path owners can indicate when not to use their path based on a variety of inputs (e.g. weather, day, time, etc.). According to some implementations, the addition of the private paths can be performed manually by the owner of the path. Further, the route management component 104 and/or the usage component 204 can add paths and/or remove paths based on multiple inputs from a controller.

The movement component 108 can slow down and/or speed up traffic based on controller inputs, including providing intelligent priority to, for example, first responders. According to some implementations, the request time can impact the value of the path based on traffic flow through the network.

A settlement component 206 can provide a discount if the requested arrival time committed to is not met. In some cases, if the object 118 enters the system and movement of the object begins and an earlier time is needed, the assessment component 106 can adjust the value of the paths and/or provide an incentive to other objects in order for the requesting object to meet it updated time of arrival. For example, the object or an entity associated with the object can purchase a slot from another object/entity.

According to some implementations, reservation pricing is available by time of day and day of week. Alternatively, or additionally, subscription pricing can be available by time of day and day of week. The pricing can be used to distribute traffic on many paths and different times of the day. According to some implementations, the pricing can fluctuate by end user type (e.g., business, taxpayer, visitor, and so on). In some cases, there can be a discount or green attribute pricing for vehicles that are considered to be “green” or environmentally conscious or can have a lesser negative impact to the environment as compared to other objects. In some implementations, billing can occur by size and/or mass of the object, referred to as capacity of the object. The bill can be sent to the object requesting access, the entity requesting the access (e.g., via the user equipment 120), or to a third party requesting an object to move through the smart grid routing network (e.g. receiver).

In further detail, a path can be owned, created, destroyed, and/or can have associated privacy considerations. A path can be a physical or logical space to be traveled over or through, including control over all events that take place upon the path to assure the desired optimum transit against desired parameters for that transit (e.g., time to destination over a municipal path could be manipulated by controlling traffic signals in the traveler's favor). A path belongs to a domain, as outlined below. Paths can be owned by an individual (e.g., private land, pass through corridor within a building, driveways, airspace, farmland, and so on), by municipalities (e.g., standard roads and signals) and can be built and within and authenticated as owned by blockchain ledger. Path usages can be added to the ledger and verified under several potential parameters and rulesets. Such parameters and/or rulesets can include whether the path is rented for exclusive use, whether several entities transverse the path simultaneously, whether the billing for the usage of the path has been paid (e.g., has an owner been compensated for its use), and so on. Transits between paths are recorded as the terminal event within the blockchain ledger for each use or transit. Such records merit blockchain for privacy, tax recording, legal concerns, prevention or mitigation of fraud (e.g., a given entity creating paths to which the entity does not have access via outright ownership or right and billing for transits thereby) can be facilitated. Availability of a given path is maintained as stated above within a blockchain ledger accessible to the system. Destruction of a given path (e.g., the path owner no longer wishes to offer it) is managed by termination of the individual blockchain entry to the grand ledger and/or placing that chain under suspension. Domains can be defined by private/public, geography, county, state, country, and so forth, and this applies to all dimensions. Domain controllers can interface with other components thru a gateway to provide unlimited coverage capability.

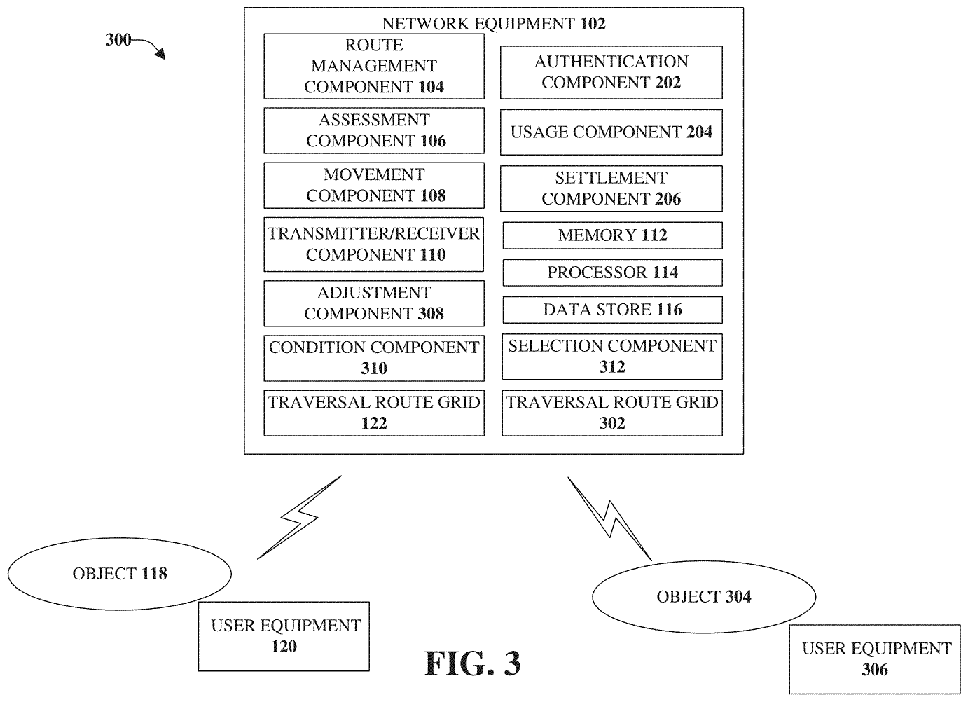

FIG. 3 illustrates an example, non-limiting, system 300 that facilitates providing a multitude of virtual paths for moving multiple objects in accordance with one or more embodiments described herein. Repetitive description of like elements employed in other embodiments described herein is omitted for sake of brevity. The system 300 can include one or more of the components and/or functionality of the system 100, the system 200, and vice versa.

The system 300, as well as other systems and/or embodiments provided herein has the ability to instantiate, manage, sell, and terminate paths. These paths are built by path owners in non-real-time and are transited and paid for by travelers in real time. Paths are multivariate and serve as an optional means of transit against any parameter built in the system. As such, a communication infrastructure can be utilized for, billing for the path creation/destruction service; billing for traveler access to the system and therefore to the paths; commission brokerage for path sales; tack-on sales for users of a given path (e.g., advertising for local businesses into smart cars for users of a given, oft used path (e.g., true municipal tool road), and for generating revenue through overall build/maintenance of the system. The utility of the paths for the travelers is simplicity itself, namely, an optimized transit experience as optimized over traveler selected parameters. The selected parameter can be, but is not limited to, time to arrival, fuel consumption, maximal enjoyment (scenic route), proximity of venues along or at termination of the path (“we want to go to Lake Bart and have ice cream along the way”), and much more. The path owners benefit through creation and sales of the path; aforesaid creation/use/destruction/limits maintained under a secure blockchain ledger for all such purposes, the latter to preserve taxation/use records as one example.

The route management component 104 can determine multiple traversal route grids for multiple objects. For example, the route management component 104 can determine the traversal route grid 122 for the object 118 and a second traversal route grid 302 for a second object 304. The second object 304 can be associated with a user equipment 306. The user equipment 120 and the user equipment 306 can be the same user equipment (e.g., the object 118 and the second object 304 are managed by the same entity) or can be different user equipment (e.g., the object 118 and the second object 304 are managed by different entities). The route management component 104 can also determine other traversal route grids for other objects. The traversal route grids (e.g., the traversal route grid 122, the second traversal route grid 302, other traversal route grids) can be overlapping traversal route grids, according to some implementations.

The network equipment 102 can include an adjustment component 308 that can adjust the second traversal route grid 302 for the second object 304 based on a determination that an adjustment to the second traversal route grid supports the requested time of arrival at the target node for the first object.

For example, the adjustment component 308 can increase a first value for a first segment of the multiple alternative route segments of the first traversal route grid. At substantially the same time, the adjustment component 308 can provide an incentive to the second object based on the adjustment to the second traversal route grid 302.

In further detail, the adjustment component 308 can identify respective locations of objects (e.g., the object 118, the second object 304), within the traversal route grid 122. A condition component 310 can determine whether an event has occurred that will impact (negatively or positively) the time of arrival or another parameter associated with movement of one or more objects. For example, the event can be an accident, an emergency situation (e.g., house fire and the road is blocked by emergency equipment), a change to a time of arrival requested by an object, changing weather conditions, and so on.

Based on occurrence of an event, the adjustment component 308 can modify a first travel route of the first object (e.g., the object 118) and a second travel route of a second object (e.g., the second object 304) based on detection of occurrence of an event within a portion of the traversal route grid or users consented change.

According to some implementations, availability of a first route segment of the multiple alternative route segments can be for a defined period of time. Thus, a selection component 312 can select the first route segment based on the availability of the first route segment corresponding to the requested time of arrival. Further, the selection component 312 can select a second route segment of the multiple alternative route segments based on the availability of the first route segment failing to correspond to the requested time of arrival, which can be determined by the condition component 310. The first route segment and the second route segment are interchangeable route segments.

In some cases, the desired time of guaranteed arrival cannot be achieved due to various circumstances. Accordingly, the assessment component can provide a discount or refund due to missing the arrival time.

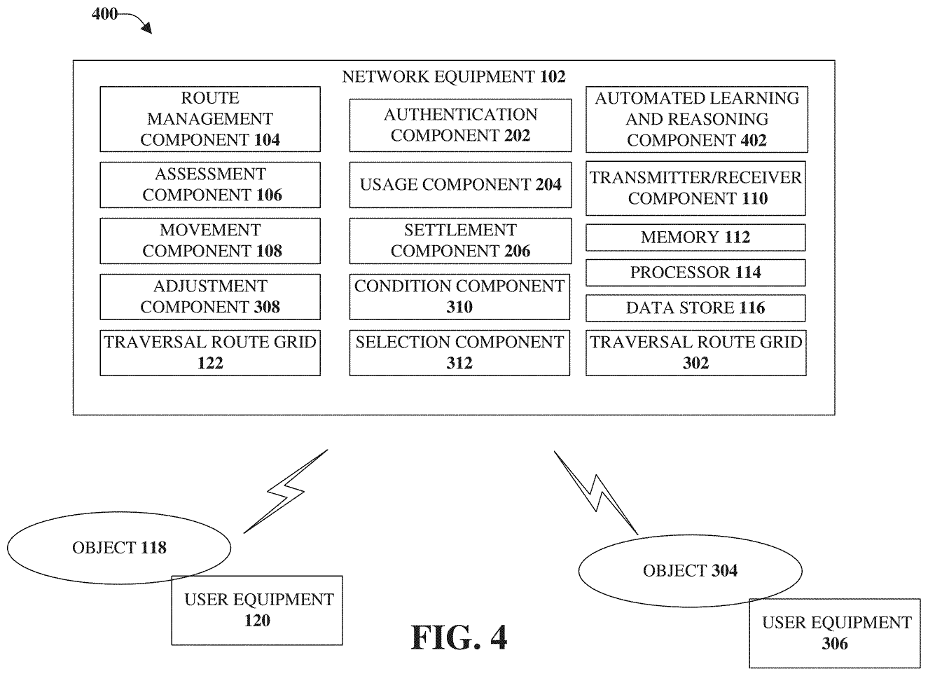

FIG. 4 illustrates an example, non-limiting, system 400 that employs automated learning to facilitate one or more of the disclosed aspects in accordance with one or more embodiments described herein. Repetitive description of like elements employed in other embodiments described herein is omitted for sake of brevity. The system 400 can include one or more of the components and/or functionality of the system 100, the system 200, the system 300, and vice versa.

As illustrated, the network equipment 102 can include an automated learning and reasoning component 402 that can be utilized to automate one or more of the disclosed aspects. The automated learning and reasoning component 402 can employ automated learning and reasoning procedures (e.g., the use of explicitly and/or implicitly trained statistical classifiers) in connection with performing inference and/or probabilistic determinations and/or statistical-based determinations in accordance with one or more aspects described herein.

For example, the automated learning and reasoning component 402 can employ principles of probabilistic and decision theoretic inference. Additionally, or alternatively, the automated learning and reasoning component 402 can rely on predictive models constructed using automated learning and/or automated learning procedures. Logic-centric inference can also be employed separately or in conjunction with probabilistic methods.

The automated learning and reasoning component 402 can infer different paths that can be used and/or the value of each path by obtaining knowledge about the various objects to be moved, preferences of an entity associated with the object, what the entity is attempting to accomplish by moving the object, the purpose of the movement of the object, or combinations thereof. Based on this knowledge, the automated learning and reasoning component 402 can make an inference based on which path to utilize, whether one or more alternative paths are available, a value of the path to the object or entity associated with the object, an incentive to be offered for use of one or more paths (such as to a private entity), and so on. Other inferences related to which path to utilize can include, but are not limited to, avoiding flood zones during rain, train patterns, a path determined to be a safest path, and so on. For example, paths could also be the safest path, resulting in lower insurance rates if taken (e.g., if raining, avoids low crossing areas).

As used herein, the term “inference” refers generally to the process of reasoning about or inferring states of a system, a component, a module, an environment, and/or devices from a set of observations as captured through events, reports, data and/or through other forms of communication. Inference can be employed to identify a one or more paths, one or more values, or can generate a probability distribution over states, for example. The inference can be probabilistic. For example, computation of a probability distribution over states of interest based on a consideration of data and/or events. The inference can also refer to techniques employed for composing higher-level events from a set of events and/or data. Such inference can result in the construction of new events and/or actions from a set of observed events and/or stored event data, whether or not the events are correlated in close temporal proximity, and whether the events and/or data come from one or several events and/or data sources. Various classification schemes and/or systems (e.g., support vector machines, neural networks, logic-centric production systems, Bayesian belief networks, fuzzy logic, data fusion engines, and so on) can be employed in connection with performing automatic and/or inferred action in connection with the disclosed aspects.

If the automated learning and reasoning component 402 has uncertainty related to the intent or request, the automated learning and reasoning component 402 can automatically engage in a short (or long) dialogue or interaction with the entity (e.g., “Can the time of arrival be moved 5 minutes?”). In accordance with some aspects, the automated learning and reasoning component 402 engages in the dialogue with the entity through another system component. Computations of the value of information can be employed to drive the asking of questions. Alternatively or additionally, a cognitive agent component (not shown) and/or the automated learning and reasoning component 402 can anticipate object actions (e.g., “where is the object heading to?”) and continually, periodically, or based on another interval, update a hypothesis as more object actions are gathered. The cognitive agent component can accumulate data or perform other actions that are a result of anticipation of future actions of the object or other objects.

The various aspects (e.g., in connection with determining one or more alternative routes, determining values of portions of the one or more alternative routes, distinguishing a selection of a route from selections of other routes and the reasoning for such selections, implementation of actions to be taken to satisfy the request, and so forth) can employ various artificial intelligence-based schemes for carrying out various aspects thereof. For example, a process for determining if a particular request is non-changeable or if the request is flexible (e.g., a requested time of arrival at 2:15 p.m., but can be as late as 2:30 p.m.) can be enabled through an automatic classifier system and process.

A classifier is a function that maps an input attribute vector, x=(x1, x2, x3, x4, xn), to a confidence that the input belongs to a class. In other words, f(x)=confidence(class). Such classification can employ a probabilistic and/or statistical-based analysis (e.g., factoring into the analysis utilities and costs) to provide a prognosis and/or infer one or more actions that should be employed to determine how to move objects within a smart grid and the values associated with the movement. In the case of routes, for example, attributes can be identification of alternative routes, ownership of the routes, restrictions or preferences associated with the route and the classes are criteria of a destination of an object, a requested time of arrival, parameters associated with the object and so forth that should be considered to satisfy the request.

A Support Vector Machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that can be similar, but not necessarily identical to training data. Other directed and undirected model classification approaches (e.g., naïve Bayes, Bayesian networks, decision trees, neural networks, fuzzy logic models, and probabilistic classification models) providing different patterns of independence can be employed. Classification as used herein, can be inclusive of statistical regression that is utilized to develop models of priority.

One or more aspects can employ classifiers that are explicitly trained (e.g., through a generic training data) as well as classifiers that are implicitly trained (e.g., by observing object travel patterns, the amount of objects moving along routes and/or within a defined grid area, by receiving extrinsic information, and so on). For example, SVMs can be configured through a learning or training phase within a classifier constructor and feature selection module. Thus, a classifier(s) can be used to automatically learn and perform a number of functions, including but not limited to determining, according to a predetermined criterion, when to implement an action related to one or more objects (e.g., alter a route), which action to implement (e.g., which route to use), what objects to group together (e.g., similar destinations), relationships between objects (e.g., controlled by a same entity), and so forth. The criteria can include, but is not limited to, similar requests, similar time periods (e.g., during the day between 10 a.m. and 10:20 a.m.), historical information, and so forth.

Additionally, or alternatively, an implementation scheme (e.g., a rule, a policy, and so on) can be applied to control and/or regulate requests and resulting values of the routes, whether a route is closed during a particular time and/or conditions, and so forth. In some implementations, based upon a predefined criterion, the rules-based implementation can automatically and/or dynamically implement movement of one or more objects. In response thereto, the rule-based implementation can automatically interpret and carry out functions associated with the objects by employing a predefined and/or programmed rule(s) based upon any desired criteria. For example, the automated learning and reasoning component 402 can slow down and/or speed up traffic (e.g., movement of the objects) based on one or more controller inputs, including providing intelligent priority to first responders. Further, the automated learning and reasoning component 402 can adjust values of the routes, or portions thereof and/or provide a recommended value or a recommended pricing based on a type of entity, a type of object, an owner of the route, and so on. In addition, the automated learning and reasoning component 402 can determine whether it is acceptable to oversubscribe a route.

Methods that can be implemented in accordance with the disclosed subject matter will be better appreciated with reference to various flow charts. While, for purposes of simplicity of explanation, the methods are shown and described as a series of blocks, it is to be understood and appreciated that the disclosed aspects are not limited by the number or order of blocks, as some blocks can occur in different orders and/or at substantially the same time with other blocks from what is depicted and described herein. Moreover, not all illustrated blocks can be required to implement the disclosed methods. It is to be appreciated that the functionality associated with the blocks can be implemented by software, hardware, a combination thereof, or any other suitable means (e.g., device, system, process, component, and so forth). Additionally, it should be further appreciated that the disclosed methods are capable of being stored on an article of manufacture to facilitate transporting and transferring such methods to various devices. Those skilled in the art will understand and appreciate that the methods could alternatively be represented as a series of interrelated states or events, such as in a state diagram.

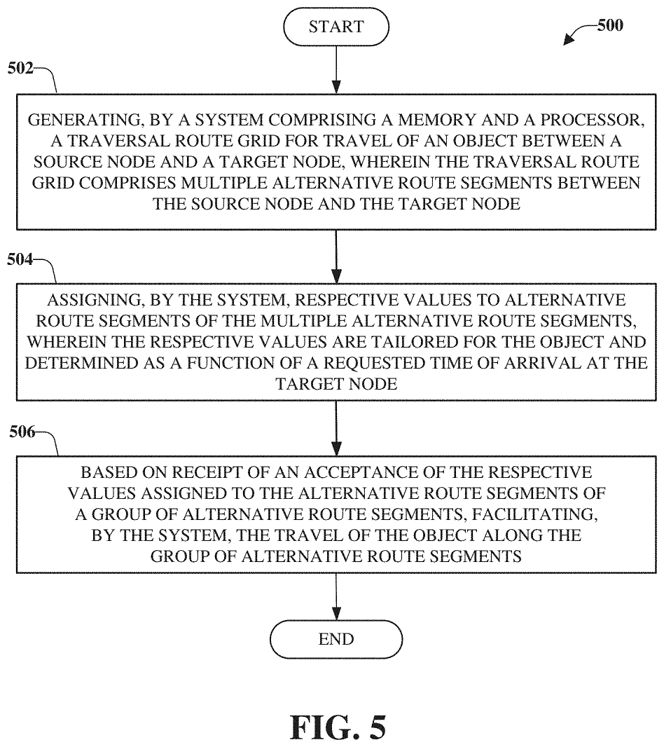

FIG. 5 illustrates a flow diagram of an example, non-limiting, computer-implemented method 500 for facilitating implementation of a multitude of virtual paths for moving an object in advanced networks in accordance with one or more embodiments described herein. Repetitive description of like elements employed in other embodiments described herein is omitted for sake of brevity.

In some implementations, a system comprising a processor can perform the computer-implemented method 500 and/or other methods discussed herein. In other implementations, a device comprising a processor can perform the computer-implemented method 500 and/or other methods discussed herein. In other implementations, a machine-readable medium, can include executable instructions that, when executed by a processor, facilitate performance of operations, which can be the operations discussed with respect to the computer-implemented method 500 and/or other methods discussed herein. In further implementations, a machine readable or computer readable storage device comprising executable instructions that, in response to execution, cause a system comprising a processor to perform operations, which can be operations discussed with respect to the computer-implemented method 500 and/or other methods discussed herein. Further, in some implementations, various equipment comprising at least one processor can perform the computer-implemented method 500 and/or other methods discussed herein.

The computer-implemented method 500 starts at 502, with generating, by a system comprising a memory and a processor, a traversal route grid for travel of an object between a source node and a target node (e.g., via the route management component 104). The traversal route grid can include multiple alternative route segments between the source node and the target node. According to some implementations, the traversal route grid can be represented as a three-dimensional space and a time element. Further, the object can be a physical object moving in the three-dimensional space.

At 504, the system can assign respective values to alternative route segments of the multiple alternative route segments (e.g., via the assessment component 106). The respective values can be tailored for the object and can be determined as a function of a requested time of arrival at the target node.

According to some implementations, after assignment of the respective values first information indicative of the respective values and second information indicative of the alternative route segments can be output to a user equipment associated with the object. The information can be output via a communications network configured to operate according to a 5G communications protocol. The information output can also include a request for acceptance or denial of the route and/or selection of another route.

Further, based on receipt of an acceptance of the respective values assigned to the alternative route segments of a group of alternative route segments, at 506 the system can facilitate the travel of the object along the group of alternative route segments (e.g., via the movement component 108). For example, the object can travel a certain route based on directions provided. In another example, the object can be automatically steered through the route.

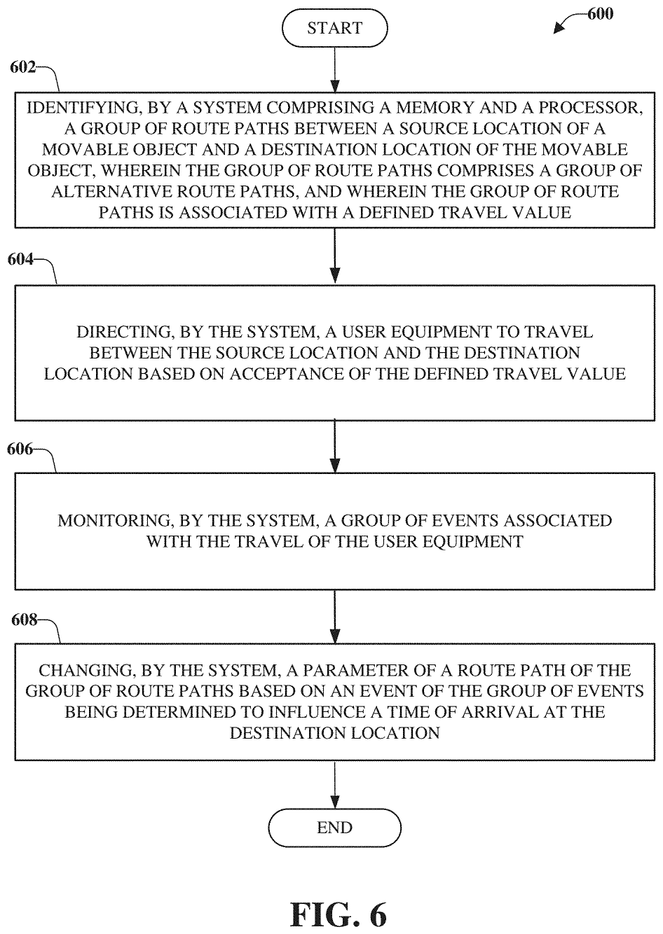

FIG. 6 illustrates a flow diagram of an example, non-limiting, computer-implemented method 600 for altering a route based on changing conditions in accordance with one or more embodiments described herein. Repetitive description of like elements employed in other embodiments described herein is omitted for sake of brevity.

At 602, a group of route paths between a source location of a movable object and a destination location of the movable object can be identified (e.g., via the route management component 104). The group of route paths can include a group of alternative route paths. Further, the group of route paths can be associated with a defined travel value.

A user equipment can be directed, at 604, between the source location and the destination location based on acceptance of the defined travel value (e.g., via the movement component 108). For example, indications of the route and associated value can be output at the user equipment or a related device. The route and associated value can be accepted, denied, and/or an alternative pricing and related route can be accepted.

A group of events associated with the travel of the user equipment can be monitored, at 604 (e.g., via the condition component 310). Events of the group of events can include, but are not limited to, weather conditions, traffic congestion, traffic accidents, malfunction of one or more objects, man-made disasters, natural disasters, a change to a requested time of arrival of a subject object or another object, and so on. Further, at 608, the system can change a parameter of a route path of the group of route paths based on an event of the group of events being determined to influence a time of arrival at the destination location.

For example, the event can be an object travel congestion on the route path. Thus, changing the parameter can include changing a location of another user equipment on the route path. Thus, the subject user equipment can have priority and the other user equipment can be requested to, or directed to, move to a defined position in the route path (e.g., move to a side of the road, move to the right lane of traffic, and so on). According to another example, the other user equipment can be requested to, or directed to, move to an alternative route path other than the route path used by the subject user equipment.

According to some implementations, the user equipment can be classified as a type of device capable of horizontal movement and vertical movement. For example, the user equipment can be a drone, an aircraft, a shipping vessel, a jet pack, a rocket belt, a rocket pack, and so on. In additional, or alternative, implementations, the user equipment can be configured to operate according to a 5G communication protocol, a 6G communication protocol, or another advanced communication protocol.

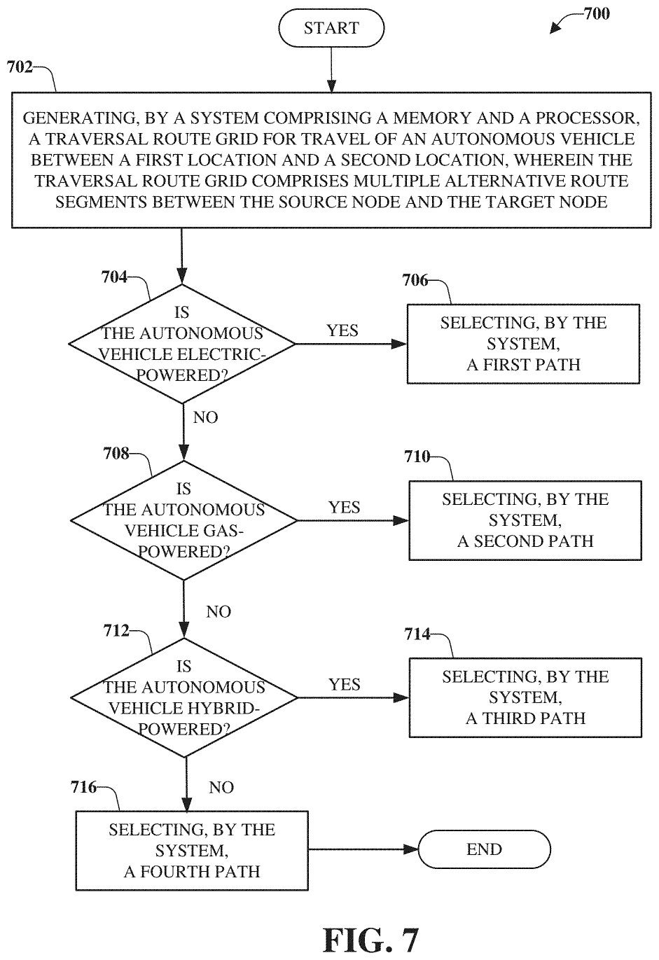

FIG. 7 illustrates a flow diagram of an example, non-limiting, computer-implemented method 700 for selecting between alternative routes in accordance with one or more embodiments described herein. Repetitive description of like elements employed in other embodiments described herein is omitted for sake of brevity.

The computer-implemented method starts, at 702, when a traversal route grid for travel of an autonomous vehicle from a first location to at least a second location is generated (e.g., via the route management component 104). The traversal route grid can include multiple alternative route segments between the first location and the second location. Generating the traversal route grid can include choosing a path from a group of paths based on a type of autonomous vehicle.

Accordingly, determinations can be made related to the type of object being considered. Thus, at 704, a first determination can be made whether the autonomous vehicle is an electric-powered vehicle. If yes, at 706, a first path can be selected. The first path can be a path that provides opportunities to recharge one or more batteries of the autonomous vehicle. For example, the opportunities can include one or more charging stations along the route. In another example, the opportunities can include more braking action in order to cause charging of the one or more batteries of the autonomous vehicle (e.g., more stops, more traffic lights, more turns, and so on).

If the determination at 704 is that the autonomous vehicle is an electric-powered vehicle (“NO”), at 708 a determination can be made whether the autonomous vehicle is a gas-powered vehicle. If the vehicle is gas-powered (“YES”), at 710, a second path can be chosen. The second path can be a path that has more gas stations and/or service station locations than other paths. According to some implementations, the first path and the second path can be the same path.

Further, if the determination at 708 is that the vehicle is not a gas-powered vehicle, a third determination can be made, at 712, whether the autonomous vehicle is a hybrid-powered vehicle. If so (“YES”), at 714, a third path can be selected for the autonomous vehicle. According to some implementations, the third path can be the same as the first path or the same as the second path. However, in some implementations, the third path can be a different path than the first path and the second path.

If the third determination is that the autonomous vehicle is not a gas-powered vehicle or the type of vehicle is not known (“NO”), a fourth path can be selected at 716. The fourth path can be different from the first path, the second path, and the third path. In some cases, the fourth path can be the same as one of the first path, the second path, and the third path.

In accordance with some implementations, the selection of the first path at 706, selection of the second path at 710, and/or selection of the third path at 714 can be contingent upon acceptance of the path. Accordingly, if the respective path is not acceptable, another path can be chosen, which can be based on preferences, rules, policies, historical information associated with the object and/or entity, and so on. Further, any of the paths can consider such parameters in addition to the consideration as to the type of autonomous vehicle. The autonomous vehicle can be moved along the selected route (or an alternative route thereof) as discussed herein.

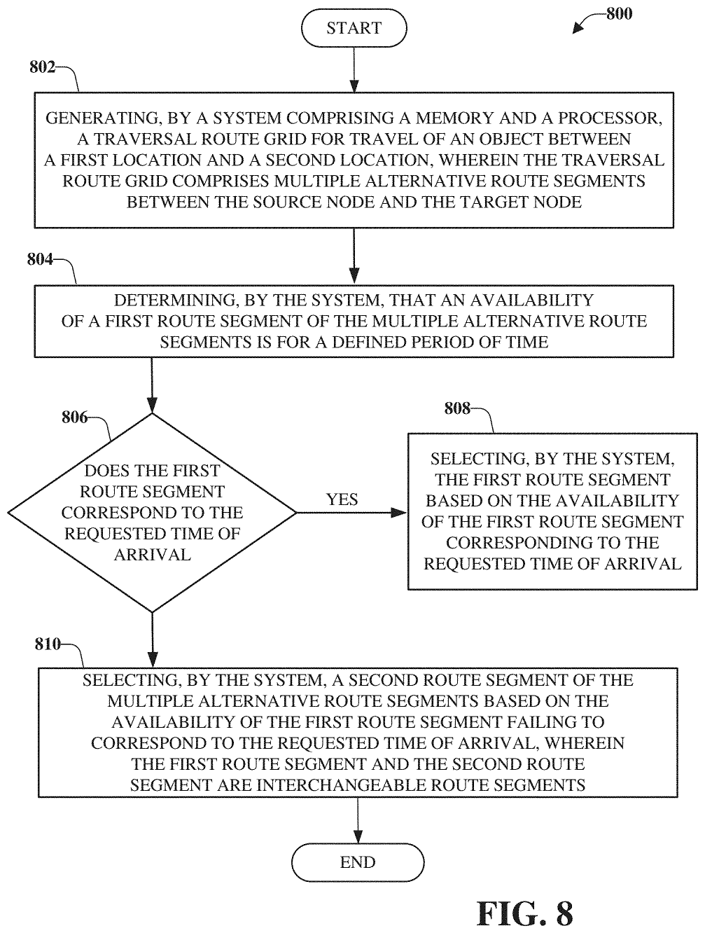

FIG. 8 illustrates a flow diagram of an example, non-limiting, computer-implemented method 800 for changing a route based on a defined time of arrival in accordance with one or more embodiments described herein. Repetitive description of like elements employed in other embodiments described herein is omitted for sake of brevity.

A traversal route grid for travel of an object from a first location to at least a second location can be generated at 802. The traversal route grid can include multiple alternative route segments between the first location and the second location. At 804, a determination can be made that an availability of a first route segment of the multiple alternative route segments is for a defined period of time. For example, the first route can be a private route that is only open during certain hours of a day or certain days of the week.

Thus, at 806, a determination can be made whether the first route segment corresponds to the requested time of arrival. Thus, the determination at 806 can be whether traversing the first route segment by the object will meet or exceed the requested time of arrival or whether it will not meet (or there is a question whether it will meet) the requested time of arrival.

If the determination at 806 is that the requested time of arrival will be satisfied (“YES”), while the route is available, at 808, the first route segment can be selected based on the availability of the first route segment corresponding to the requested time of arrival. For example, if the first route is available from 7 a.m. to 7:15 a.m., and the expected travel route of the object is expected to be able to use the first route segment during that time, the first route is used, provided the first route supports the time of arrival.

Alternatively, if the determination at 806 is that the requested time of arrival fails to be satisfied (“NO”), at 810, a second route segment of the multiple alternative route segments can be selected. The second route segment can be determined to satisfy the requested time of arrival. Further, the first route segment and the second route segment can be interchangeable route segments.

According to some implementations, the first route segment of the multiple alternative route segments can be a private route and the second route segment of the multiple alternative route segments can be a public route. The owner of the private route can be compensated for a use of the private route. In some implementations, a public entity associated with the public route can be compensated for use of the public route.

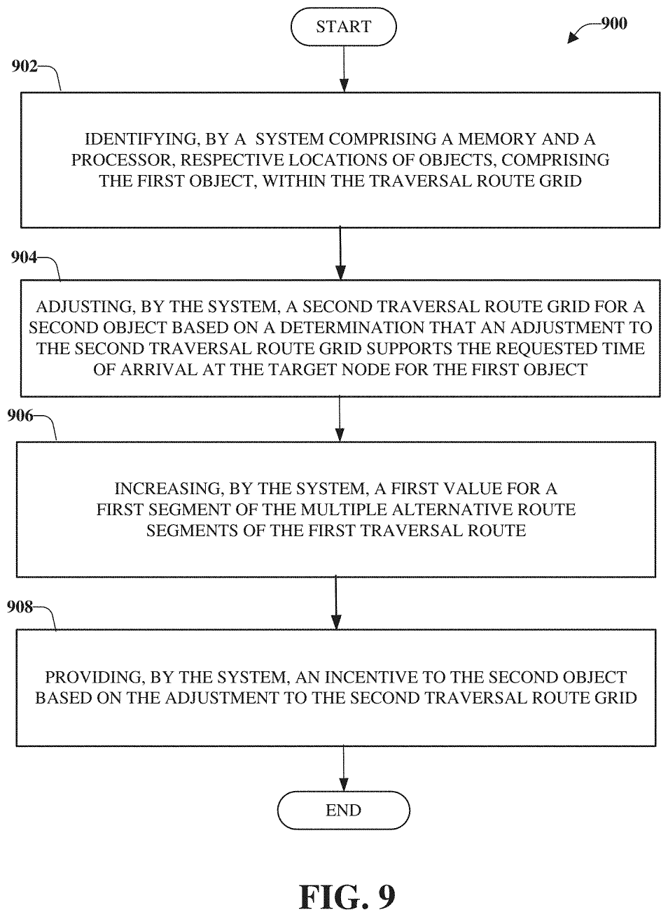

FIG. 9 illustrates a flow diagram of an example, non-limiting, computer-implemented method 900 for benefiting a first object based on a change to a travel route of a second object in accordance with one or more embodiments described herein. Repetitive description of like elements employed in other embodiments described herein is omitted for sake of brevity.

During traversal of objects within respective traversal route grids, at 902, respective locations of objects can be identified. The objects can include a first object and at least a second object. According to an example, the first object can have priority over a second object. For example, the first object could be associated with a premium subscription (e.g., paid more for guaranteed time of arrival). In another example, the first object can be a vehicle that has two or more passengers (e.g., a high occupancy).

In some cases, if an event occurs that impacts one or more objects, travel routes of the one or more objects can be modified. For example, an accident can occur on a road and can cause a traffic back up that negatively impacts a time of arrival. If an alternate route is available, the one or more objects (or a subset thereof) can be directed to the alternate route.

In some cases, an object, such as the first object, can take priority over another object, such as the second object. Accordingly, at 904, a second traversal route grid for the second object can be adjusted. This adjustment can be based on a determination that an adjustment to the second traversal route grid supports the requested time of arrival at the target node for the first object.

According to some implementations, to adjust the second traversal route grid, at 906 the computer-implemented method 900 can increase a first value for a first segment of the multiple alternative route segments of the first traversal route. For example, the increase to the first value can be a price increase associated with traveling the route by the first object. Further, at 910, an incentive can be provided to the second object based on the adjustment to the second traversal route grid. The incentive can be a discount for use of the system according to some implementations.

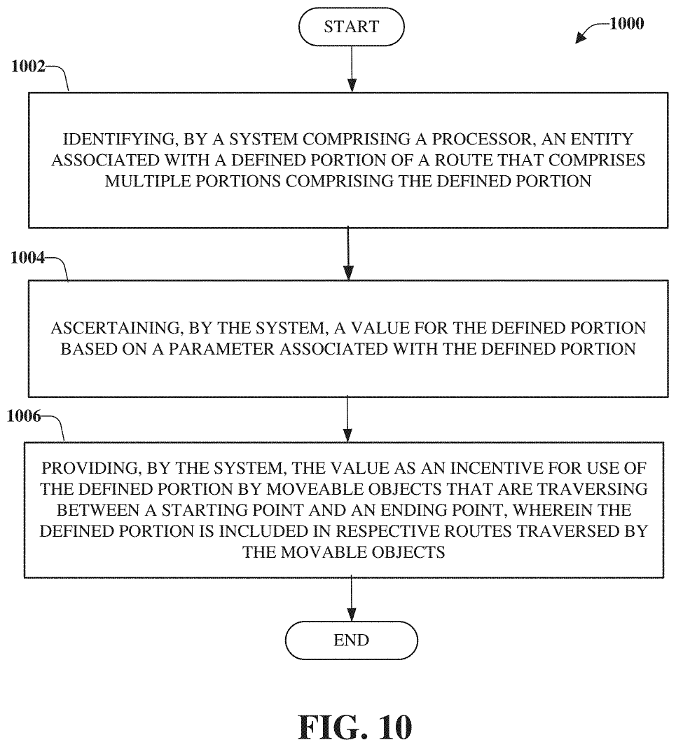

FIG. 10 illustrates a flow diagram of an example, non-limiting, computer-implemented method 1000 for providing value for use of a portion of a route in accordance with one or more embodiments described herein. Repetitive description of like elements employed in other embodiments described herein is omitted for sake of brevity.

The computer-implemented method 1000 can start, at 1002, with identification of an entity associated with a defined portion of a route that includes multiple portions comprising the defined portion. The entity can be identified based on a request from the entity to include a portion of a route owned by the entity into the system as discussed herein.

Further, at 1004, the system can ascertain a value for the defined portion based on a parameter associated with the defined portion. For example, the parameter can include an amount of time saved by the movable objects when traversing the defined portion as compared to use of an alternative route by the movable objects. In some implementations, the value for the defined portion can be changeable based on a number of movable objects using the defined portion during an identified time period.

At 1006, the computer-implemented method 1000 can provide the value as an incentive for use of the defined portion by movable objects that are traversing between a starting point and an ending point. The defined portion can be included in respective routes traversed by the movable objects.

Described herein are systems, methods, articles of manufacture, and other embodiments or implementations that can facilitate implementation of a multitude of virtual paths for moving one or more objects in advanced networks. Facilitating implementation of a multitude of virtual paths for moving one or more objects in advanced networks can be implemented in connection with any type of device with a connection to the communications network (e.g., a mobile handset, a computer, a handheld device, etc.) any Internet of things (IoT) device (e.g., toaster, coffee maker, blinds, music players, speakers, water meter, etc.), and/or any connected vehicles (e.g., cars, airplanes, boats, space rockets, and/or other at least partially automated vehicles (e.g., drones), and so on). In some embodiments, the non-limiting term User Equipment (UE) is used. It can refer to any type of wireless device that communicates with a radio network node in a cellular or mobile communication system. Examples of UE are target device, device to device (D2D) UE, machine type UE or UE capable of machine to machine (M2M) communication, PDA, Tablet, mobile terminals, smart phone, Laptop Embedded Equipped (LEE), laptop mounted equipment (LME), USB dongles etc. Note that the terms element, elements and antenna ports can be interchangeably used but carry the same meaning in this disclosure. The embodiments are applicable to single carrier as well as to Multi-Carrier (MC) or Carrier Aggregation (CA) operation of the UE. The term Carrier Aggregation (CA) is also called (e.g., interchangeably called) “multi-carrier system,” “multi-cell operation,” “multi-carrier operation,” “multi-carrier” transmission and/or reception.

In some embodiments, the non-limiting term radio network node or simply network node is used. It can refer to any type of network node that serves one or more UEs and/or that is coupled to other network nodes or network elements or any radio node from where the one or more UEs receive a signal. Examples of radio network nodes are Node B, Base Station (BS), Multi-Standard Radio (MSR) node such as MSR BS, eNode B, network controller, Radio Network Controller (RNC), Base Station Controller (BSC), relay, donor node controlling relay, Base Transceiver Station (BTS), Access Point (AP), transmission points, transmission nodes, RRU, RRH, nodes in Distributed Antenna System (DAS) etc.

To meet the huge demand for data centric applications, 4G standards can be applied to 5G, also called New Radio (NR) access. The 5G networks can include the following: data rates of several tens of megabits per second supported for tens of thousands of users; 1 gigabit per second can be offered simultaneously (or concurrently) to tens of workers on the same office floor; several hundreds of thousands of simultaneous (or concurrent) connections can be supported for massive sensor deployments; spectral efficiency can be enhanced compared to 4G; improved coverage; enhanced signaling efficiency; and reduced latency compared to Long Term Evolution (LTE).

Multiple Input, Multiple Output (MIMO) systems can significantly increase the data carrying capacity of wireless systems. For these reasons, MIMO is an integral part of the third and fourth generation wireless systems (e.g., 3G and 4G). In addition, 5G systems also employ MIMO systems, which are referred to as massive MIMO systems (e.g., hundreds of antennas at the transmitter side (e.g., network) and/receiver side (e.g., user equipment). With a (Nₜ,Nᵣ) system, where Nₜ denotes the number of transmit antennas and Nr denotes the receive antennas, the peak data rate multiplies with a factor of Nₜ over single antenna systems in rich scattering environment.

In addition, advanced networks, such as a 5G network can be configured to provide more bandwidth than the bandwidth available in other networks (e.g., a 4G network). A 5G network can be configured to provide more ubiquitous connectivity. In addition, more potential of applications and services, such as connected infrastructure, wearable computers, autonomous driving, seamless virtual and augmented reality, “ultra-high-fidelity” virtual reality, and so on, can be provided with 5G networks. Such applications and/or services can consume a large amount of bandwidth. For example, some applications and/or services can consume about fifty times the bandwidth of a high-definition video stream, Internet of Everything (IoE), and others. Further, various applications can have different network performance requirements (e.g., latency requirements and so on).

Cloud Radio Access Networks (cRAN) can enable the implementation of concepts such as SDN and Network Function Virtualization (NFV) in 5G networks. This disclosure can facilitate a generic channel state information framework design for a 5G network. Certain embodiments of this disclosure can include an SDN controller that can control routing of traffic within the network and between the network and traffic destinations. The SDN controller can be merged with the 5G network architecture to enable service deliveries via open Application Programming Interfaces (APIs) and move the network core towards an all Internet Protocol (IP), cloud based, and software driven telecommunications network. The SDN controller can work with, or take the place of, Policy and Charging Rules Function (PCRF) network elements so that policies such as quality of service and traffic management and routing can be synchronized and managed end to end.

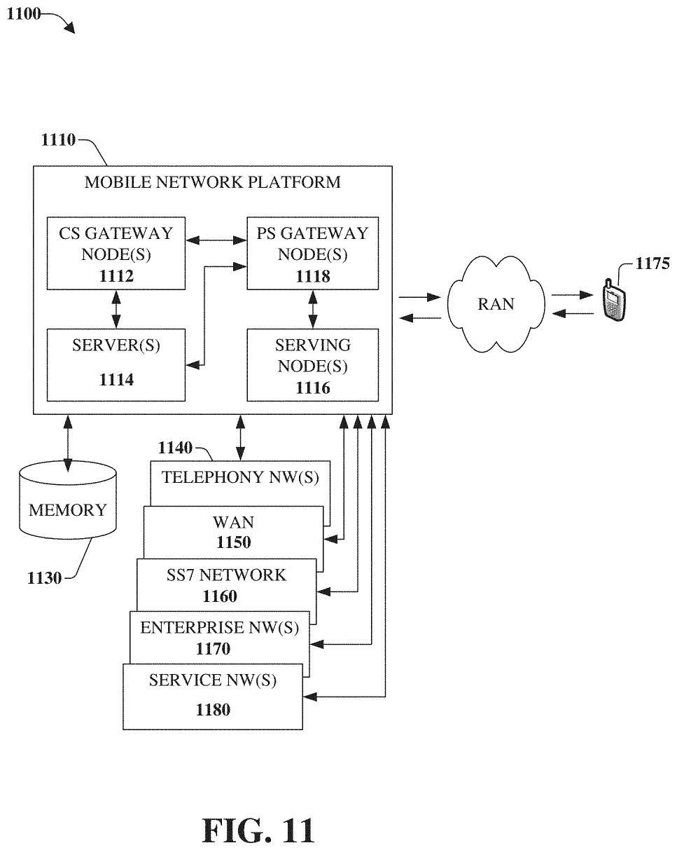

FIG. 11 presents an example embodiment 1100 of a mobile network platform 1110 that can implement and exploit one or more aspects of the disclosed subject matter described herein. Generally, wireless network platform 1110 can include components, e.g., nodes, gateways, interfaces, servers, or disparate platforms, that facilitate both packet-switched (PS) (e.g., Internet protocol (IP), frame relay, asynchronous transfer mode (ATM) and circuit-switched (CS) traffic (e.g., voice and data), as well as control generation for networked wireless telecommunication. As a non-limiting example, wireless network platform 1110 can be included in telecommunications carrier networks, and can be considered carrier-side components as discussed elsewhere herein. Mobile network platform 1110 includes CS gateway node(s) 1112 which can interface CS traffic received from legacy networks such as telephony network(s) 1140 (e.g., public switched telephone network (PSTN), or public land mobile network (PLMN)) or a signaling system #7 (SS7) network 1160. Circuit switched gateway node(s) 1112 can authorize and authenticate traffic (e.g., voice) arising from such networks. Additionally, CS gateway node(s) 1112 can access mobility, or roaming, data generated through SS7 network 1160; for instance, mobility data stored in a visited location register (VLR), which can reside in memory 1130. Moreover, CS gateway node(s) 1112 interfaces CS-based traffic and signaling and PS gateway node(s) 1118. As an example, in a 3GPP UMTS network, CS gateway node(s) 1112 can be realized at least in part in gateway GPRS support node(s) (GGSN). It should be appreciated that functionality and specific operation of CS gateway node(s) 1112, PS gateway node(s) 1118, and serving node(s) 1116, is provided and dictated by radio technology(ies) utilized by mobile network platform 1110 for telecommunication. Mobile network platform 1110 can also include the MMEs, HSS/PCRFs, SGWs, and PGWs disclosed herein.

In addition to receiving and processing CS-switched traffic and signaling, PS gateway node(s) 1118 can authorize and authenticate PS-based data sessions with served mobile devices. Data sessions can include traffic, or content(s), exchanged with networks external to the wireless network platform 1110, like wide area network(s) (WANs) 1150, enterprise network(s) 1170, and service network(s) 1180, which can be embodied in local area network(s) (LANs), can also be interfaced with mobile network platform 1110 through PS gateway node(s) 1118. It is to be noted that WANs 1150 and enterprise network(s) 1170 can embody, at least in part, a service network(s) such as IP multimedia subsystem (IMS). Based on radio technology layer(s) available in technology resource(s) 1117, packet-switched gateway node(s) 1118 can generate packet data protocol contexts when a data session is established; other data structures that facilitate routing of packetized data also can be generated. To that end, in an aspect, PS gateway node(s) 1118 can include a tunnel interface (e.g., tunnel termination gateway (TTG) in 3GPP UMTS network(s) (not shown)) which can facilitate packetized communication with disparate wireless network(s), such as Wi-Fi networks.

In embodiment 1100, wireless network platform 1110 also includes serving node(s) 1116 that, based upon available radio technology layer(s) within technology resource(s) 1117, convey the various packetized flows of data streams received through PS gateway node(s) 1118. It is to be noted that for technology resource(s) 1117 that rely primarily on CS communication, server node(s) can deliver traffic without reliance on PS gateway node(s) 1118; for example, server node(s) can embody at least in part a mobile switching center. As an example, in a 3GPP UMTS network, serving node(s) 1116 can be embodied in serving GPRS support node(s) (SGSN).

For radio technologies that exploit packetized communication, server(s) 1114 in wireless network platform 1110 can execute numerous applications that can generate multiple disparate packetized data streams or flows, and manage (e.g., schedule, queue, format, and so on) such flows. Such application(s) can include add-on features to standard services (for example, provisioning, billing, user support, and so forth) provided by wireless network platform 1110. Data streams (e.g., content(s) that are part of a voice call or data session) can be conveyed to PS gateway node(s) 1118 for authorization/authentication and initiation of a data session, and to serving node(s) 1116 for communication thereafter. In addition to application server, server(s) 1114 can include utility server(s), a utility server can include a provisioning server, an operations and maintenance server, a security server that can implement at least in part a certificate authority and firewalls as well as other security mechanisms, and the like. In an aspect, security server(s) secure communication served through wireless network platform 1110 to ensure network's operation and data integrity in addition to authorization and authentication procedures that CS gateway node(s) 1112 and PS gateway node(s) 1118 can enact. Moreover, provisioning server(s) can provision services from external network(s) like networks operated by a disparate service provider; for instance, WAN 1150 or Global Positioning System (GPS) network(s) (not shown). Provisioning server(s) can also provision coverage through networks associated to wireless network platform 1110 (e.g., deployed and operated by the same service provider), such as femto-cell network(s) (not shown) that enhance wireless service coverage within indoor confined spaces and offload RAN resources in order to enhance subscriber service experience within a home or business environment by way of UE 1175.

It is to be noted that server(s) 1114 can include one or more processors configured to confer at least in part the functionality of macro network platform 1110. To that end, the one or more processor can execute code instructions stored in memory 1130, for example. It should be appreciated that server(s) 1114 can include a content manager 1115, which operates in substantially the same manner as described hereinbefore.

In example embodiment 1100, memory 1130 can store information related to operation of wireless network platform 1110. Other operational information can include provisioning information of mobile devices served through wireless network platform 1110, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 1130 can also store information from at least one of telephony network(s) 1140, WAN 1150, enterprise network(s) 1170, or SS7 network 1160. In an aspect, memory 1130 can be, for example, accessed as part of a data store component or as a remotely connected memory store.

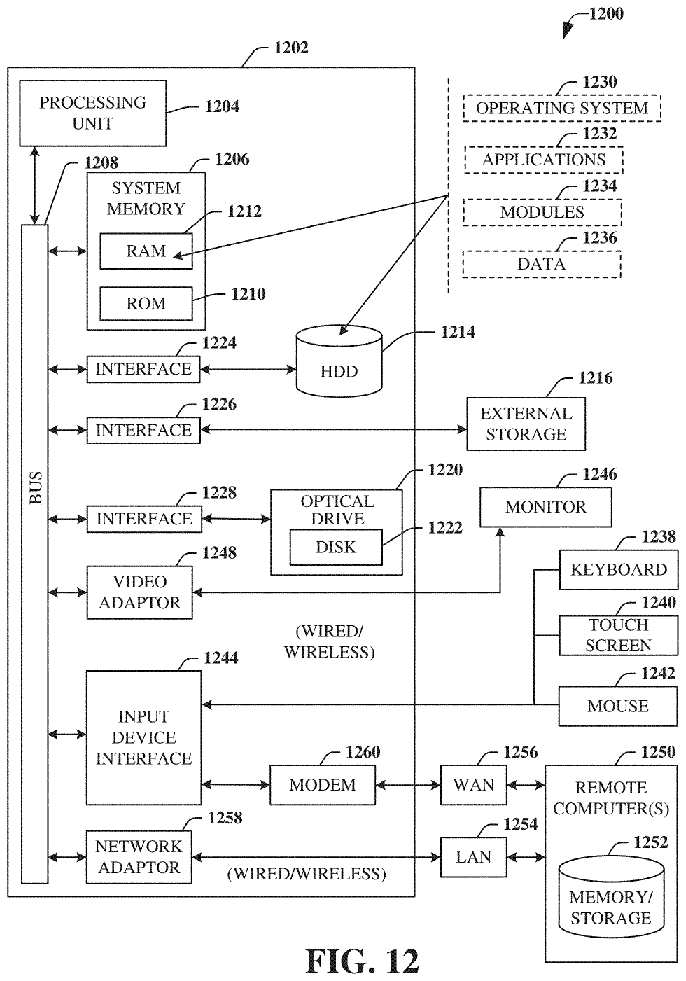

In order to provide additional context for various embodiments described herein, FIG. 12 and the following discussion are intended to provide a brief, general description of an example, non-limiting, computing environment 1200 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 12, the example computing environment 1200 for implementing various embodiments of the aspects described herein includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures can also be employed as the processing unit 1204.

The system bus 1208 can be any of several types of bus structure that can further interconnect to a memory bus (with or without a memory controller), a peripheral bus, and a local bus using any of a variety of commercially available bus architectures. The system memory 1206 includes ROM 1210 and RAM 1212. A basic input/output system (BIOS) can be stored in a non-volatile memory such as ROM, erasable programmable read only memory (EPROM), EEPROM, which BIOS contains the basic routines that help to transfer information between elements within the computer 1202, such as during startup. The RAM 1212 can also include a high-speed RAM such as static RAM for caching data.

The computer 1202 further includes an internal hard disk drive (HDD) 1214 (e.g., EIDE, SATA), one or more external storage devices 1216 (e.g., a magnetic floppy disk drive (FDD) 1216, a memory stick or flash drive reader, a memory card reader, etc.) and an optical disk drive 1220 (e.g., which can read or write from a CD-ROM disc, a DVD, a BD, etc.). While the internal HDD 1214 is illustrated as located within the computer 1202, the internal HDD 1214 can also be configured for external use in a suitable chassis (not shown). Additionally, while not shown in computing environment 1200, a solid-state drive (SSD) could be used in addition to, or in place of, an internal HDD 1214. The internal HDD 1214, external storage device(s) 1216 and optical disk drive 1220 can be connected to the system bus 1208 by an HDD interface 1224, an external storage interface 1226 and an optical drive interface 1228, respectively. The HDD interface 1224 for external drive implementations can include at least one or both of Universal Serial Bus (USB) and Institute of Electrical and Electronics Engineers (IEEE) 1094 interface technologies. Other external drive connection technologies are within contemplation of the embodiments described herein.

The drives and their associated computer-readable storage media provide nonvolatile storage of data, data structures, computer-executable instructions, and so forth. For the computer 1202, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. The systems and methods described herein can be implemented utilizing various commercially available operating systems or combinations of operating systems.

Computer 1202 can optionally include emulation technologies. For example, a hypervisor (not shown) or other intermediary can emulate a hardware environment for operating system 1230, and the emulated hardware can optionally be different from the hardware illustrated in FIG. 12. In such an embodiment, operating system 1230 can include one virtual machine (VM) of multiple VMs hosted at computer 1202. Furthermore, operating system 1230 can provide runtime environments, such as the Java runtime environment or the .NET framework, for application programs 1232. Runtime environments are consistent execution environments that allow application programs 1232 to run on any operating system that includes the runtime environment. Similarly, operating system 1230 can support containers, and application programs 1232 can be in the form of containers, which are lightweight, standalone, executable packages of software that include, e.g., code, runtime, system tools, system libraries and settings for an application.

Further, computer 1202 can be enable with a security module, such as a trusted processing module (TPM). For instance, with a TPM, boot components hash next in time boot components, and wait for a match of results to secured values, before loading a next boot component. This process can take place at any layer in the code execution stack of computer 1202, e.g., applied at the application execution level or at the operating system (OS) kernel level, thereby enabling security at any level of code execution.

A user can enter commands and information into the computer 1202 through one or more wired/wireless input devices, e.g., a keyboard 1238, a touch screen 1260, and a pointing device, such as a mouse 1262. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1204 through an input device interface 1264 that can be coupled to the system bus 1208, but can be connected by other interfaces, such as a parallel port, an IEEE 1094 serial port, a game port, a USB port, an IR interface, a BLUETOOTH® interface, etc.

A monitor 1266 or other type of display device can be also connected to the system bus 1208 via an interface, such as a video adapter 1268. In addition to the monitor 1266, a computer typically includes other peripheral output devices (not shown), such as speakers, printers, etc.

The computer 1202 can operate in a networked environment using logical connections via wired and/or wireless communications to one or more remote computers, such as a remote computer(s) 1250. The remote computer(s) 1250 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1252 is illustrated. The logical connections depicted include wired/wireless connectivity to a local area network (LAN 1254) and/or larger networks, e.g., a wide area network (WAN 1256). Such LAN and WAN networking environments are commonplace in offices and companies, and facilitate enterprise-wide computer networks, such as intranets, all of which can connect to a global communications network, e.g., the Internet.

When used in a LAN networking environment, the computer 1202 can be connected to the LAN 1254 through a wired and/or wireless communication network interface or adapter 1258. The adapter 1258 can facilitate wired or wireless communication to the LAN 1254, which can also include a wireless access point (AP) disposed thereon for communicating with the adapter 1258 in a wireless mode.

When used in a WAN networking environment, the computer 1202 can include a modem 1280 or can be connected to a communications server on the WAN 1256 via other means for establishing communications over the WAN 1256, such as by way of the Internet. The modem 1280, which can be internal or external and a wired or wireless device, can be connected to the system bus 1208 via the input device interface 1264. In a networked environment, program modules depicted relative to the computer 1202 or portions thereof, can be stored in the memory/storage device 1252, which can be a remote memory/storage device. It will be appreciated that the network connections shown are example and other means of establishing a communications link between the computers can be used.

When used in either a LAN or WAN networking environment, the computer 1202 can access cloud storage systems or other network-based storage systems in addition to, or in place of, external storage devices 1216 as described above. Generally, a connection between the computer 1202 and a cloud storage system can be established over a LAN 1254 or WAN 1256 e.g., by the adapter 1258 or modem 1280, respectively. Upon connecting the computer 1202 to an associated cloud storage system, the external storage interface 1226 can, with the aid of the adapter 1258 and/or modem 1280, manage storage provided by the cloud storage system as it would other types of external storage. For instance, the external storage interface 1226 can be configured to provide access to cloud storage sources as if those sources were physically connected to the computer 1202.

The computer 1202 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

An aspect of 5G, which differentiates from previous 4G systems, is the use of NR. NR architecture can be designed to support multiple deployment cases for independent configuration of resources used for RACH procedures. Since the NR can provide additional services than those provided by LTE, efficiencies can be generated by leveraging the pros and cons of LTE and NR to facilitate the interplay between LTE and NR, as discussed herein.

Reference throughout this specification to “one embodiment,” or “an embodiment,” means that a particular feature, structure, or characteristic described in connection with the embodiment is included in at least one embodiment. Thus, the appearances of the phrase “in one embodiment,” “in one aspect,” or “in an embodiment,” in various places throughout this specification are not necessarily all referring to the same embodiment. Furthermore, the particular features, structures, or characteristics can be combined in any suitable manner in one or more embodiments. The term “include” can be used interchangeably with the term “comprise,” or variants thereof.

As used in this disclosure, in some embodiments, the terms “component,” “system,” “interface,” and the like are intended to refer to, or include, a computer-related entity or an entity related to an operational apparatus with one or more specific functionalities, wherein the entity can be either hardware, a combination of hardware and software, software, or software in execution, and/or firmware. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software application or firmware application executed by one or more processors, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confer(s) at least in part the functionality of the electronic components. In an aspect, a component can emulate an electronic component via a virtual machine, e.g., within a cloud computing system. While various components have been illustrated as separate components, it will be appreciated that multiple components can be implemented as a single component, or a single component can be implemented as multiple components, without departing from example embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “Node B (NB),” “evolved Node B (eNode B),” “home Node B (HNB)” and the like, are utilized interchangeably in the application, and refer to a wireless network component or appliance that transmits and/or receives data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

Embodiments described herein can be exploited in substantially any wireless communication technology, comprising, but not limited to, Wireless Fidelity (Wi-Fi), Global System For Mobile Communications (GSM), Universal Mobile Telecommunications System (UMTS), Worldwide Interoperability For Microwave Access (WiMAX), enhanced General Packet Radio Service (enhanced GPRS), Third Generation Partnership Project (3GPP) long term evolution (LTE), Third Generation Partnership Project 2 (3GPP2) Ultra Mobile Broadband (UMB), high speed packet access (HSPA), Z-Wave, Zigbee and other 802.XX wireless technologies and/or legacy telecommunication technologies.

The various aspects described herein can relate to New Radio (NR), which can be deployed as a standalone radio access technology or as a non-standalone radio access technology assisted by another radio access technology, such as Long Term Evolution (LTE), for example. It should be noted that although various aspects and embodiments have been described herein in the context of 5G, Universal Mobile Telecommunications System (UMTS), and/or Long Term Evolution (LTE), or other next generation networks, the disclosed aspects are not limited to 5G, a UMTS implementation, and/or an LTE implementation as the techniques can also be applied in 3G, 4G, or LTE systems. For example, aspects or features of the disclosed embodiments can be exploited in substantially any wireless communication technology. Such wireless communication technologies can include UMTS, Code Division Multiple Access (CDMA), Wi-Fi, Worldwide Interoperability for Microwave Access (WiMAX), General Packet Radio Service (GPRS), Enhanced GPRS, Third Generation Partnership Project (3GPP), LTE, Third Generation Partnership Project 2 (3GPP2) Ultra Mobile Broadband (UMB), High Speed Packet Access (HSPA), Evolved High Speed Packet Access (HSPA+), High-Speed Downlink Packet Access (HSDPA), High-Speed Uplink Packet Access (HSUPA), Zigbee, or another IEEE 802.XX technology. Additionally, substantially all aspects disclosed herein can be exploited in legacy telecommunication technologies.

As used herein, “5G” can also be referred to as NR access. Accordingly, systems, methods, and/or machine-readable storage media for facilitating link adaptation of downlink control channel for 5G systems are desired. As used herein, one or more aspects of a 5G network can include, but is not limited to, data rates of several tens of megabits per second (Mbps) supported for tens of thousands of users; at least one gigabit per second (Gbps) to be offered simultaneously to tens of users (e.g., tens of workers on the same office floor); several hundreds of thousands of simultaneous connections supported for massive sensor deployments; spectral efficiency significantly enhanced compared to 4G; improvement in coverage relative to 4G; signaling efficiency enhanced compared to 4G; and/or latency significantly reduced compared to LTE.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference can be employed to identify a specific context or action, or can generate a probability distribution over states of interest based on a consideration of data and events, for example.

Inference can also refer to techniques employed for composing higher-level events from a set of events and/or data. Such inference results in the construction of new events or actions from a set of observed events and/or stored event data, whether the events are correlated in close temporal proximity, and whether the events and data come from one or several event and data sources. Various classification procedures and/or systems (e.g., support vector machines, neural networks, expert systems, Bayesian belief networks, fuzzy logic, and data fusion engines) can be employed in connection with performing automatic and/or inferred action in connection with the disclosed subject matter.

In addition, the various embodiments can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, machine-readable device, computer-readable carrier, computer-readable media, machine-readable media, computer-readable (or machine-readable) storage/communication media. For example, computer-readable media can include, but are not limited to, a magnetic storage device, e.g., hard disk; floppy disk; magnetic strip(s); an optical disk (e.g., compact disk (CD), a digital video disc (DVD), a Blu-ray Disc™ (BD)); a smart card; a flash memory device (e.g., card, stick, key drive); and/or a virtual device that emulates a storage device and/or any of the above computer-readable media. Of course, those skilled in the art will recognize many modifications can be made to this configuration without departing from the scope or spirit of the various embodiments

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the subject matter has been described herein in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
generating, by a system comprising a memory and a processor, a traversal route grid for travel of an object between a source node and a target node, wherein the traversal route grid comprises multiple alternative route segments between the source node and the target node;
assigning, by the system, respective values to alternative route segments of the multiple alternative route segments, wherein the respective values are tailored for the object and determined as a function of a requested time of arrival at the target node; and
based on receipt of an acceptance of the respective values assigned to the alternative route segments of a group of alternative route segments, facilitating, by the system, the travel of the object along the group of alternative route segments.

2. The method of claim 1, wherein the object is a first object, wherein the traversal route grid is a first traversal route grid, and wherein the method further comprises:
adjusting, by the system, a second traversal route grid for a second object based on a determination that an adjustment to the second traversal route grid supports the requested time of arrival at the target node for the first object.

3. The method of claim 2, wherein the adjusting comprises:
increasing a first value for a first segment of the multiple alternative route segments of the first traversal route grid; and
providing an incentive to the second object based on the adjustment to the second traversal route grid.

4. The method of claim 1, wherein the traversal route grid is represented as a three-dimensional space and a time element.

5. The method of claim 1, wherein the object is an autonomous vehicle, and wherein the generating comprises choosing a path from a group of paths based on a type of the autonomous vehicle.

6. The method of claim 5, wherein the choosing comprises:
selecting a first path based on the autonomous vehicle being an electric-powered vehicle;
selecting a second path based on the autonomous vehicle being a gas-powered vehicle; and
selecting a third path based on the autonomous vehicle being a hybrid-powered vehicle.

7. The method of claim 1, wherein the object is a physical object moving in a three-dimensional space.

8. The method of claim 1, wherein the generating comprises:
determining that an availability of a first route segment of the multiple alternative route segments is for a defined period of time;
selecting the first route segment based on the availability of the first route segment corresponding to the requested time of arrival; and
selecting a second route segment of the multiple alternative route segments based on the availability of the first route segment failing to correspond to the requested time of arrival, wherein the first route segment and the second route segment are interchangeable route segments.

9. The method of claim 1, wherein a first route segment of the multiple alternative route segments is a public route, wherein a second route segment of the multiple alternative route segments is a private route, and wherein an owner of the private route is compensated for a use of the private route.

10. The method of claim 1, further comprising:
prior to the facilitating, outputting, by the system, to a user equipment associated with the object, first information indicative of the respective values and second information indicative of the alternative route segments, wherein the outputting is via a communications network configured to operate according to a fifth generation communication protocol.

11. The method of claim 1, wherein the object is a first object, and wherein the method further comprises:
identifying, by the system, respective locations of objects, comprising the first object, within the traversal route grid; and
modifying, by the system, a first travel route of the first object and a second travel route of a second object based on detection of occurrence of an event within a portion of the traversal route grid.

12. A system, comprising:
a processor; and
a memory that stores executable instructions that, when executed by the processor, facilitate performance of operations, comprising:
identifying a group of route paths between a source location of a movable object and a destination location of the movable object, wherein the group of route paths comprises a group of alternative route paths, and wherein the group of route paths is associated with a defined travel value;
directing a user equipment to travel between the source location and the destination location based on acceptance of the defined travel value;
monitoring a group of events associated with the travel of the user equipment; and
changing a parameter of a route path of the group of route paths based on an event of the group of events being determined to influence a time of arrival at the destination location.

13. The system of claim 12, wherein the user equipment is a first user equipment, wherein the event is an object travel congestion on the route path, and wherein the changing comprises changing a location of a second user equipment on the route path.

14. The system of claim 13, wherein the changing comprises causing the second user equipment to move to a defined position in the route path.

15. The system of claim 13, wherein the changing comprises causing the second user equipment to move to an alternative route path other than the route path.

16. The system of claim 12, wherein the user equipment is classified as a type of device capable of horizontal movement and vertical movement.

17. The system of claim 12, wherein the user equipment is configured to operate according to a fifth generation communication protocol.

18. A non-transitory machine-readable medium, comprising executable instructions that, when executed by a processor, facilitate performance of operations, comprising:
identifying an entity associated with a defined portion of a route that comprises multiple portions comprising the defined portion;
ascertaining a value for the defined portion based on a parameter associated with the defined portion; and
providing the value as an incentive for use of the defined portion by movable objects that are traversing between a starting point and an ending point, wherein the defined portion is included in respective routes traversed by the movable objects.

19. The non-transitory machine-readable medium of claim 18, wherein the parameter comprises an amount of time saved by the movable objects when traversing the defined portion as compared to use of an alternative route by the movable objects.

20. The non-transitory machine-readable medium of claim 18, wherein the value for the defined portion is changeable based on a number of movable objects using the defined portion during an identified time period.
